(19) United States
(12) Patent Application Publication
(10) Pub. No.: US 2008/0145544 A1
(43) Pub. Date: Jun. 19, 2008

(54) Method and Device for Producing Polyurethane Foam Slab Stock

(76) Inventors: Martin Schamberg, Sankt Augustin (DE); Jurgen Wirth, Koln (DE)

Correspondence Address: LUCAS & MERCANTI, LLP, 475 PARK AVENUE SOUTH, 15TH FLOOR, NEW YORK, NY, 10016, US

(21) Appl. No.: 11/883,310

(22) PCT Filed: Feb. 1, 2006
(86) PCT No.: PCT/EP2006/000866

§ 371 Date: Jan. 17, 2008

(30) Foreign Application Priority Data
Feb. 4, 2005 (DE) 10 2005 005 151.0

(51) Int. Cl. B05D 3/00; B05C 11/00

(52) U.S. Cl. 427/373; 118/612

(57) ABSTRACT

The invention relates to a method for manufacturing polyurethane block foam whereby the reactive components polyol and isocyanate are conveyed in a metered fashion to a mixer 1, are mixed therein and then discharged from the mixer and applied to the substrate paper 3, characterised in that after leaving the mixer the reactive mixture flows through a distributor device arranged immediately above the substrate paper, the flow velocities of the mixture portions flowing out from the edge of the distributor device substantially transversely to the transport direction being higher than the flow velocities of the mixture portions flowing out substantially in the transport direction from the leading edge of the distributor device in the transport direction, and the reactive mixture leaving the distributor device in the form of a film which forms a boundary face with the ambient atmosphere only on the upper side.

The invention relates to a method and a device for manufacturing polyurethane block foam.

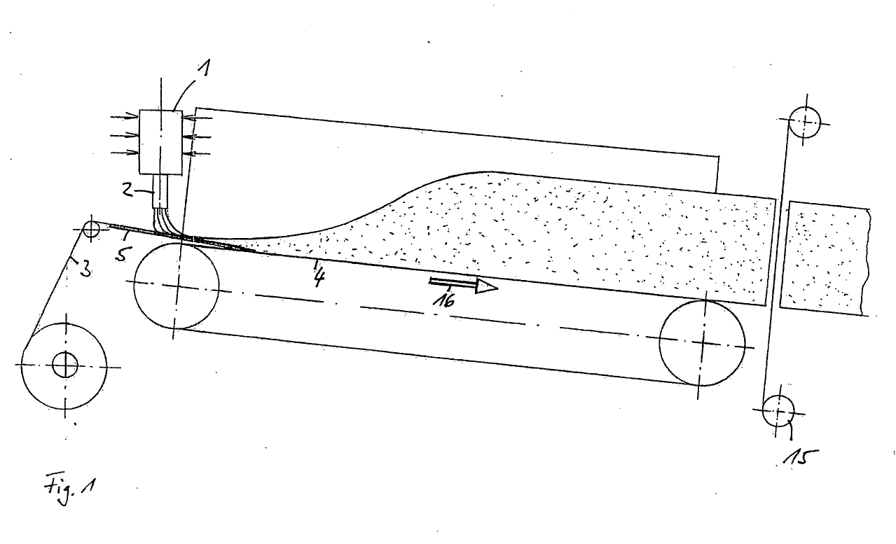

In the manufacture of block foam, e.g. of polyurethane (PUR) in a continuous process, the reactive components polyol and isocyanate and further additives such as catalysts, stabilisers, blowing agents and colorants are dosed with one another in exact mixing ratios, then supplied to a mixer and mixed together therein. Paddle mixers are conventionally used but static mixers may also be used. After mixing, the reactive mixture is applied to the substrate paper of a circulating conveyor belt or, as represented in FIG. 1, to the substrate paper drawn across an application plate, and conveyed onwards by the conveyor belt to the block foam plant itself, where it foams and cures. The foamed material thus produced is then cut into blocks and transported to storage where it is ventilated and cooled before being released for further fabrication.

In this whole process the manner in which the reactive mixture is applied to the substrate paper transported over the conveyor belt or the application plate is of decisive importance for the quality of the block foam then produced. For example, even the smallest air bubbles which are churned in or mixed into eddy zones lead to pinholes and blowholes in the subsequent reaction and blowing process, and therefore to a product of inferior quality.

The following situation is also of especial importance:

After the mixing process, which is usually ended within approximately 0.3 to 1 s and not more than 2 s, and the elapse of the start time, the chemical reaction begins and then expansion through the formation of blowing gas. When the reactive mixture is applied to the substrate paper in a swelling flow, the problem arises that the reactive mixture at the centre of the substrate paper runs ahead of the lateral portions, viewed in the transport direction. Backflow of the reactive mixture against the transport direction is prevented by flow guards.

In addition, the pulse forces of the flow at the centre are directed in the transport direction and laterally against the side walls. This additionally reinforces the effect that the middle portion of the flow runs ahead, and has the result that mixture of different ages is present in each plane perpendicular to the transport direction. This in turn has the negative effect that the older mixture in the edge regions of the substrate paper, which reacts and expands earlier, pushes adjacent younger mixture backwards. This pushing in turn causes cellular striations, varying densities, different cell structures and ultimately rupture and therefore rejects.

To counter these general problems of the block foam process, in the early stages of this technology the mixer was caused to traverse perpendicularly to the transport direction. This involves, firstly, extremely high technical complexity and cost and, secondly, technical disadvantages, because an enormous quantity of air is beaten into the mixture.

To counter these shortcomings, attempts have been made to develop special dispensing or application systems for the reactive mixture in order to produce high-quality block foam even with “stationary” mixers.

For example, a so-called “crossbeam” or discharge beam is described in DE-OS-27 03 680. However, this has not been adopted in the technology, firstly, because it must be dismantled and cleaned in a highly complex and costly manner after each foaming process and, secondly, above all because it had a tendency to become foam-blocked, especially at the ends. This is especially the case because the development of block foams has led to higher reactivity.

DE-OS-39 05 914 describes a further dispensing system. Here a distributor nozzle, formed by two side walls delimiting a narrow gap which is open downwardly and to the sides (column 3, lines 29 to 31 and FIGS. 1 and 2 of DE-OS-39 05 914), is connected to the outlet of a mixing head.

In column 1, lines 45 to 48 of DE-OS-39 05 914 it is further stated that the flow resistance to the mixture stream is higher vertically downwards and lower towards the sides, so that a uniform and very broad fan is produced.

This distribution system, too, has not been adopted. This is because an enormous quantity of small air bubbles is mixed in an uncontrolled manner into the reactive mixture flowing vertically downwards, so that pinholes and blowholes are then produced in the foaming reactive mixture by the blowing gas diffusing into these macro-air nuclei, leading to a product of inferior quality or even to rejection. The uncontrolled mixing of small air bubbles into the reactive mixture occurs in various ways: firstly, because of the height of fall and the resulting “splashing”, but also because of the wholly undefined flow on the conveyor belt or the substrate paper disposed thereon, small air bubbles being “sucked in” between the substrate paper and the reactive mixture.

The object therefore still remains to make available a simple and economical method and a corresponding device for manufacturing polyurethane block foam, in which the discharge system does not become foam-blocked, in which PUR block foam can be obtained with few or no blowholes or pinholes, and in which a homogenous distribution of the mixture is effected that produces mixture of the same age across the width of the block.

The invention relates to a method for manufacturing polyurethane block foam whereby the reactive components polyol and isocyanate are conveyed in a metered fashion to a mixer, are mixed therein and then discharged from the mixer and applied to the substrate paper, characterised in that after leaving the mixer the reactive mixture flows through a distributor device arranged immediately above the substrate paper, the flow velocities of the mixture portions flowing out from the edge of the distributor device substantially transversely to the transport direction being higher than the flow velocities of the mixture portions flowing out substantially in the transport direction from the leading edge of the distributor device in the transport direction, and the reactive mixture leaving the distributor device in the form of a film which forms a boundary layer with the ambient atmosphere only at the upper side.

A method is preferred in which the reactive mixture, after leaving the mixer, flows through a distributor device arranged immediately above the substrate paper, with which distributor device the reactive mixture is guided substantially parallel to the surface of the substrate paper.

The substrate paper is usually the paper web or other suitable separating web which rests on the conveyor belt and/or the application plate and is moved across it. The substrate paper may therefore optionally consist of a material other than paper.

In the method according to the invention the reactive mixture, after leaving the mixing zone or a mixture discharge passage directly downstream from it, is so guided that it flows out immediately above the substrate paper (i.e. also immediately above the conveyor belt or the application plate) into ambient atmosphere, while passing through a distributor device (distributor tongue). The reactive mixture preferably flows out parallel to the surface of the substrate paper (or of the conveyor belt or of the application plate). The distributor device causes the flow velocities of the mixture portions flowing out from the edge of the distributor device substantially transversely to the transport direction to be higher than the flow velocities of the mixture portions flowing out in the transport direction in the central region of the distributor device, preferably by a factor of 1.5 to 200, especially preferably by a factor of 2.0 to 100, very especially preferably by a factor of 2.5 to 50. This has the effect that, after leaving the distributor device, a mixture distribution with constant layer thickness across the width of the substrate paper is established and the reactive mixture moves in a parallel flow at constant velocity across the width of the substrate paper, the flow velocity matching the transport velocity of the conveyor belt or of the substrate paper. This also means that no relative velocity is now present between substrate paper and reactive mixture.

The distributor device is arranged immediately above the substrate paper, i.e. preferably at a distance of up to 50 mm, especially preferably of less than 10 mm.

In this way it is achieved that mixture of the same age is present with constant layer thickness in each plane viewed across the width of the block, so that during the reaction and blowing process no displacements against the transport direction can occur and the expanding mixture can rise only upwardly. In this way, therefore, block foam without cellular striations, without cell disturbances, without differences of density and without ruptures can be produced.

It is also possible with this method to produce block foam free of pinholes and blowholes because the guided outflow of the reactive mixture into the atmosphere zone takes place immediately above the substrate paper, without any “splashing”, so that churning of small air bubbles into the reactive mixture is not possible. The reactive mixture leaves the distributor device in the form of a film which forms a boundary face with the ambient atmosphere on only one side, the upper side.

The invention also relates to a device for manufacturing polyurethane block foam comprising reservoirs for the reactive components polyol and isocyanate, pumps and conduits for metering the reactive components from the reservoirs to a mixer, a conveyor belt and/or an application plate over which is transported a substrate paper to which the reactive mixture is applied, characterised in that there is arranged between the mixer and the substrate paper a distributor device which defines a gap through which the reactive mixture flows and which is arranged immediately above the substrate paper, the distributor device being in contact with the substrate paper. The device according to the invention is preferably used in the method according to the invention.

In a preferred embodiment the gap through which the reactive mixture flows before exiting from the distributor device is oriented substantially parallel to the substrate paper.

According to the invention a distributor device is connected to the outlet of the mixing zone and the mixture discharge passage, which distributor device may possess approximately the contour of a tongue and defines a gap through which the reactive mixture must pass before flowing out into the ambient atmosphere and which is arranged immediately above the conveyor belt or the application plate. The gap through which the reactive mixture must pass before flowing out into the ambient atmosphere is preferably disposed substantially parallel to the substrate paper, that is, also substantially parallel to the conveyor belt or to an application plate. The cross-section of the gap may be so configured that the upper and lower part of the distributor device are arranged parallel to one another, or converge conically towards the front, i.e. viewed in the transport direction. Contoured surfaces, in particular on the inner face of the upper part of the distributor device, are also possible.

The distributor device may also be so configured that the lower side of the distributor device, that is, the side of the distributor device facing towards the substrate paper, extends further in the transport direction, and optionally also transversely to the transport direction, than the upper side of the distributor device. Because of the different extension of the lower side and the upper side of the distributor device, the reactive mixture then flows out from the distributor device through an exit aperture which is inclined with respect to the vertical.

The ratio of the width b of the distributor device to the width B of the PUR foam block produced (i.e. also to the width of the conveyor belt) is preferably 0.001 to 0.8, especially preferably 0.005 to 0.3, very especially preferably 0.01 to 0.1.

The ratio of the length l of the distributor device (in the transport direction) to the width b of the distributor device (transversely to the transport direction) is preferably 0.5 to 20, especially preferably 0.8 to 10, very especially preferably 1 to 5.

In a particular embodiment of the device the distributor device consists of a lower and an upper part, the lower part including a sheet-metal element which is inclined with respect to the substrate paper and which forms with the latter a straight transition edge at the transition to the substrate paper. The liquid film leaving the distributor gap then first flows on the sheet-metal element before flowing over this edge on to the substrate paper. A flexible sealing lip or an overlapping film is preferably attached at the transition from the sheet-metal element to the substrate paper.

In a further particular embodiment of the device the distributor device consists of a lower and an upper part, the lower part being formed by the conveyor belt and/or the application plate itself and the substrate paper resting thereon. In this case it is important that a sealing element (for example, in the form of a sealing lip) is arranged in the rearward area of the distributor device between the distributor device and the conveyor belt and/or the application plate or the substrate paper resting thereon.

A further particular embodiment of the device represents a combination of the two embodiments described previously. In this case the upper distributor tongue has a kink exactly at the transition edge of the lower sheet metal element to the substrate paper, so that the lower part of the distributor device is formed partly by the sheet-metal element and partly by the conveyor belt and/or the application plate and the substrate paper resting thereon. It is thereby prevented, firstly, that excessive pressure can act on the paper and, secondly, that the sheet-metal element becomes too wide.

In a further embodiment the distance h between the upper edge of the distributor device and the lower edge of the distributor device is adjustable.

The contour of the gap is preferably adjustable in several places, so that a mixture distribution which is as optimal as possible can also be achieved with foam of different widths, quantities and viscosities, without the need to exchange the distributor device. For this purpose the upper part of the distributor device is preferably adaptable to the given conditions through the adjustability of the gap.

The axis of symmetry of the mixing zone in the mixer or of the mixture discharge passage preferably forms with the plane of the gap of the distributor device an angle from 5° to 175°, especially preferably from 45° to 135°, very especially preferably from 80° to 100°.

In a particular embodiment of this device this angle is also adjustable.

Filling pieces may be placed in the transitional zone between the mixing zone or the mixture discharge passage and the distributor device in order to eliminate dead zones and to configure the flow pattern optimally.

The invention is explained in more detail below with reference to the following illustrations, in which:

FIG. 1 is a schematic representation of a block foam plant according to the prior art;

FIG. 2 shows a device according to the invention along the section C-C and

FIG. 3 shows the same device as in FIG. 2 along the section B-B;

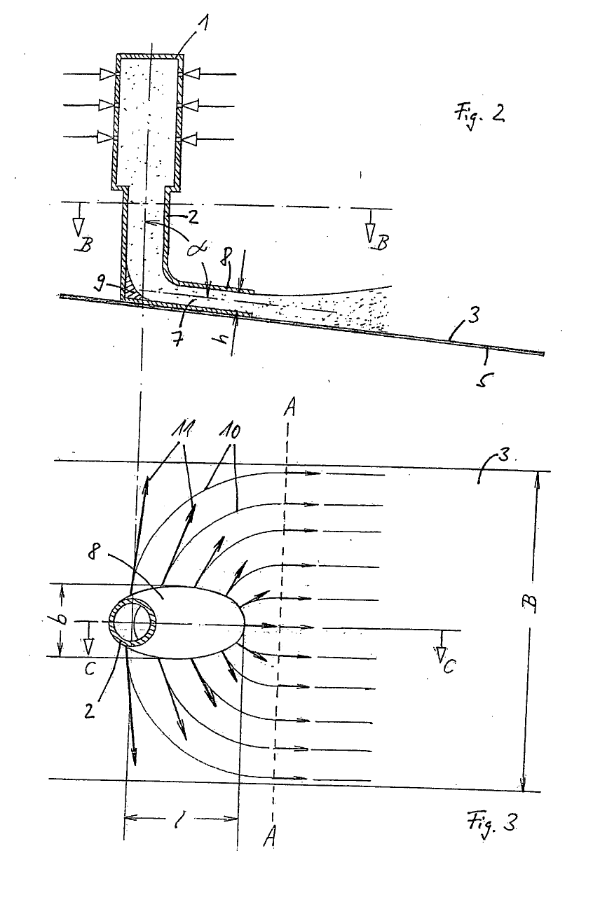

FIG. 4 shows a variant of the device according to the invention, the lower part of the distributor device being formed by the application plate itself;

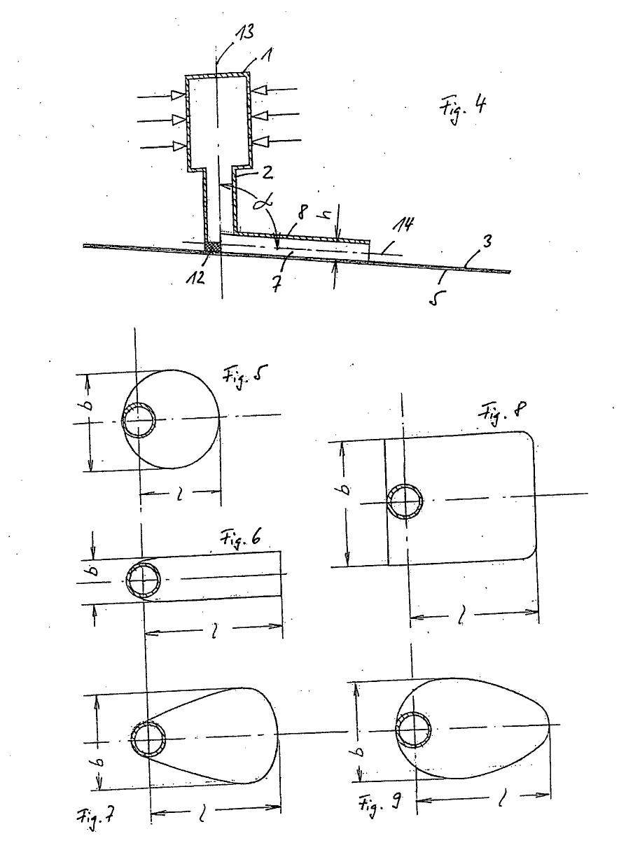

FIGS. 5 to 9 show variants of the distributor device.

FIG. 1 shows a plant for manufacturing PUR block foam according to the prior art. In it the reactive components polyol and isocyanate and the additives are conveyed continuously in precise mixing proportions by means of metering pumps (not shown) to a mixer 1, are mixed therein and applied via a discharge passage 2 to the substrate paper 3 which is drawn by the conveyor belt 4 over the application plate 5, and are then conveyed onwards by the conveyor belt 4 into the block foam plant itself where it foams and cures. The arrow 16 indicates the transport direction of the conveyor belt. The foamed material thus produced is cut into blocks by means of a saw device 15 and transported to a place of storage.

FIG. 2 shows a device according to the invention along the section C-C (the position of the section C-C is shown in FIG. 3). The reactive components polyol and isocyanate and the additives are conveyed continuously in exact mixing proportions to the mixer 1 and mixed therein.

After a transit time of approximately 0.3 to 1 s, not more than 2 s, the reactive mixture leaves the mixer 1 via the mixture discharge passage 2. The ready reactive mixture is then guided in such a way that it flows out immediately above the application plate 5 parallel to the application plate.

This is effected in that the reactive mixture flows through the gap 7 of the distributor device 8. The outflow of the reactive mixture takes place without “splashing” and therefore without any beating-in of small air bubbles. The reactive mixture leaves the distributor device 8 in the form of a film which forms a boundary face with the ambient atmosphere on only one side, namely the upper side. In order to eliminate dead zones in the flow, a filling piece 9 is arranged in the inlet of the distributor tongue.

FIG. 3 shows the device according to the invention represented in FIG. 2, but along the section B-B. The essential feature of this Figure is the representation of the flow lines 10 of the outflowing reactive mixture.

It is also indicated by the velocity vectors 11 associated with the flow lines 10 that the flow velocities of the mixture portions flowing out from the edge of the distributor device 8 substantially transversely to the transport direction are distinctly higher than the flow velocities of the mixture portions flowing out from the central region of the distributor tongue in the transport direction. This has the result that mixture of the same age with constant layer thickness is present everywhere across the whole width B of the block in the plane A-A. The width ratio b:B in this example is approximately 0.2 and the l:b ratio approximately 2.

FIG. 4 shows a variant of the device according to the invention in which the distributor device 8 consists of an upper and a lower part, the lower part of the distributor device 8 being formed by the application plate 5 itself and the substrate paper 3 arranged thereon. In this embodiment a sealing element 12 is arranged in the rearward area of the distributor device 8 between the distributor device 8 and the application plate 5.

The axis of symmetry 13 of the mixer 1 and the mixture discharge passage 2 and the plane 14 of the distributor device 8 form the angle α with one another. This angle may also be adjustable (not shown in detail) in order to be able to adapt the system to changing inclinations of the application plate.

FIGS. 5, 6, 7, 8 and 9 show embodiments of different distributor devices 8; not only the shape but also the ratio values l:b and b:B may be variable.

The novel method and the novel device can be used in variable ways. It is immaterial whether the substrate paper to which the reactive mixture is applied is drawn along below the mixing head and the application element in a predefined transport direction or whether, in so-called stationary block foam plants, the mixing head and the dispensing element are moved along above the fixed substrate paper.

1. Method for manufacturing polyurethane block foam, whereby the reactive components polyol and isocyanate are conveyed in a metered fashion to a mixer (1), are mixed therein and then discharged from the mixer and applied to the substrate paper (3), characterised in that after leaving the mixer the reactive mixture flows through a distributor device (8) arranged immediately above the substrate paper, the flow velocities of the mixture portions flowing out from the edge of the distributor device substantially transversely to the transport direction being higher than the flow velocities of the mixture portions flowing out substantially in the transport direction from the leading edge of the distributor device (8) in the transport direction, and the reactive mixture leaving the distributor device (8) in the form of a film which forms a boundary face with the ambient atmosphere only on the upper side.

2. Method according to claim 1, characterised in that the flow velocities of the mixture portions flowing out from the edge of the distributor device (8) substantially transversely to the transport direction are higher by a factor of 1.5 to 200, preferably by a factor of 2.0 to 100, especially preferably by a factor of 2.5 to 50, than the flow velocities of the mixture portions flowing out substantially in the transport direction from the leading edge in the transport direction.

3. Method according to claim 1 or 2, characterised in that the reactive mixture is guided substantially parallel to the surface of the substrate paper as it flows through the distributor device.

4. Device for manufacturing polyurethane block foam, comprising reservoirs for the reactive components polyol and isocyanate, pumps and conduits for metering the reactive components from the reservoirs to a mixer (1), and a conveyor belt (4) and/or an application plate (5) over which is transported a substrate paper (3) to which the reactive mixture is applied, characterised in that there is arranged between the mixer (1) and the substrate paper (3) a distributor device (8) which defines a gap (7) through which the reactive mixture flows and which is arranged immediately above the substrate paper (3), the distributor device being in contact with the substrate paper.

5. Device according to claim 4, characterised in that the ratio of the width b of the distributor device (8) to the width B of the block foam produced is 0.001 to 0.8, preferably 0.005 to 0.3, especially preferably 0.01 to 0.1.

6. Device according to either of claims 4 or 5, characterised in that the ratio of the length l of the distributor device (8) to the width b of the distributor device (8) is 0.5 to 20, preferably 0.8 to 10, especially preferably 1.0 to 5.

7. Device according to any one of claims 4 to 6, characterised in that the distributor device (8) is formed by an upper part and a lower part, the lower part being formed by the conveyor belt (4) and/or the application plate (5) and the substrate paper (3) resting thereon.

8. Device according to claim 7, characterised in that a sealing element (12) is arranged in the rearward area of the distributor device (8) between the distributor device (8) and the substrate paper (3).

9. Device according to any one of claims 4 to 8, characterised in that the distance h between the upper edge of the distributor device (8) and the lower edge of the distributor device (8) is adjustable.

10. Device according to any one of claims 4 to 9, characterised in that the angle α between the axis of symmetry (13) of the mixing zone or of the mixture discharge passage (2) and the plane of the distributor device (8) is 5° to 175°, preferably 45° to 135°, especially preferably 80° to 100°, and in that this angle α is adjustable.
